(19) United States
(12) Patent Application Publication
(10) Pub. No.: US 2020/0167861 A1
(43) Pub. Date: May 28, 2020

(54) SECURE DATA ACQUISITION AND PROCESSING SYSTEM

(71) Applicant: Solar Mosaic, Inc., Oakland, CA (US)

(72) Inventors: Dhanur Grandhi Ramaswamy, San Francisco, CA (US); Ericson de Agosto, Oakland, CA (US)

(21) Appl. No.: 16/199,600

(22) Filed: Nov. 26, 2018

(51) Int. Cl. G06Q 40/02; H04L 29/06; G06F 21/60; G06F 16/2458; G06Q 20/32

(52) U.S. Cl. CPC G06Q 40/025; H04L 63/08; G06Q 2220/00; G06F 16/2468; G06Q 20/3223; G06F 21/602

(57) ABSTRACT

A secure data acquisition and processing system is disclosed. The system includes a secure server configured to execute one or more secure data acquisition processes during interaction with a mobile computing device operated by a user. The secure server also includes a security engine configured to execute instructions received from the secure server. The instructions cause the security engine to perform operations including tracking information uniquely identifying the mobile computing device that interacts with the secure server, and authentication processing on the user of the mobile computing device to verify and authenticate that the user of the mobile computing device is the owner of the mobile phone number used with the mobile computing device interacting with the secure server.

### TECHNICAL FIELD

This application relates a secure system for acquiring and processing data from mobile computing devices.

### BACKGROUND

Electronic payment methods and systems, such as credit card based payment system, have evolved to the point that they are generally considered to be a secure form of payment that provides relatively low transaction risks to the merchant and customer. Credit card based transactions are secured by mature and established protocols that protect against many forms of impersonation and identity theft, especially when the established protocols are followed. Such protocols include checking and comparing the signature on the credit card against the signature on the sales receipts or documents signed by the customer, and/or checking government issued photo identification provided by the customer against the name imprinted on the credit card. Fraudulent transactions that are paid by the bank and charged to the customer can be disputed and reversed. Risks are further reduced now that nearly every credit and debit card is issued with an industry standard microchip embedded into the card that further protects against fraudulent transactions.

Technology platforms continue to evolve providing new solutions that allow a broader spectrum of borrowers to obtain financial products using technology based systems for delivering financing approval processes. One type of financial technology platform that continues to gain acceptance is point of sale financing. The financial disclosure and security protocols for point of sale financing systems are less developed. For example, an organization offering financing through a technology platform may not provide clear information about the financial products being offered, such that potential customers do not clearly understand features of the financing available to them. The potential also exists for contractors offering point of sale financing for construction and home improvement projects to represent that the services provided to their customer are complete, so that funds from the customer's loan can be disbursed, when in fact the services are not complete. The technology platforms offering point of sale financing may not implement the robust security and authentication protocols necessary to prevent a loan applicant from using false or stolen identity to apply for financing. These technology platforms often do not provide adequate security checkpoints throughout the end to end phases of the loan application, approval, and funds distribution processes when mobile computing devices are used in the various financing phases, while also providing a seamless and frictionless customer experience.

### SUMMARY

According to one innovative aspect of the subject matter described in this application, a secure data acquisition and processing system includes a secure server configured to execute one or more secure data acquisition processes during interaction with a mobile computing device operated by a user. The secure server also includes a security engine configured to execute instructions received from the secure server. The instructions cause the security engine to perform operations including tracking information uniquely identifying the mobile computing device that interacts with the secure server, and authentication processing on the user of the mobile computing device to verify and authenticate that the user of the mobile computing device is the owner of the mobile phone number used with the mobile computing device interacting with the secure server.

The secure data acquisition and processing system may include one or more of the following optional features. The security engine may perform a two step verification process. The two step verification process may include the security engine executing a fuzzy matching process between a common data element retrieved from two distinct data sources that independently store the common data element. The common data element may be a name identifier of the owner of the mobile computing device, and the two distinct data sources may be a mobile network carrier database and a credit reporting service database.

The system also may cause the secure server to combine a completed loan application with metadata related to the loan application, and then perform an encryption process to cryptographically seal the loan application with the metadata to create an authoritative copy of the loan application. The secure server may store the cryptographically sealed authoritative copy in a secure database.

The details of one or more implementations of the subject matter described in this specification are set forth in the accompanying drawings and the description below. A particular advantage of the secure data acquisition and processing system is that a mobile computing device can be authenticated as a trusted device and then used to interact with a secure server to submit information into a secure loan application process. Another advantage of the secure data acquisition and processing system is that a security engine is operable to execute a customer verification technique for performing customer identity verification with a high level of confidence in a very short amount of time, which in turn provides for an improved customer experience. Other features, aspects, and advantages of the subject matter will become apparent from the description, the drawings, and the claims.

### BRIEF DESCRIPTION OF THE DRAWINGS

FIG. 1 is a diagram showing the secure data acquisition and processing system in communication with different end point devices such as mobile computing devices.

FIG. 2 is a diagram showing the end to end processing phases of the secure data acquisition and loan information processing system.

FIG. 3 is a flow diagram showing features implemented within an application running on a mobile computing device.

FIG. 4 is a flow diagram showing the security features executed between the security engine running on a secure application server and a mobile computing device.

FIG. 5 is a flow diagram illustrating a cryptographic security process applied to the loan application document finalization process.

FIG. 6 illustrates an example of a computing device and a mobile computing device.

### DETAILED DESCRIPTION

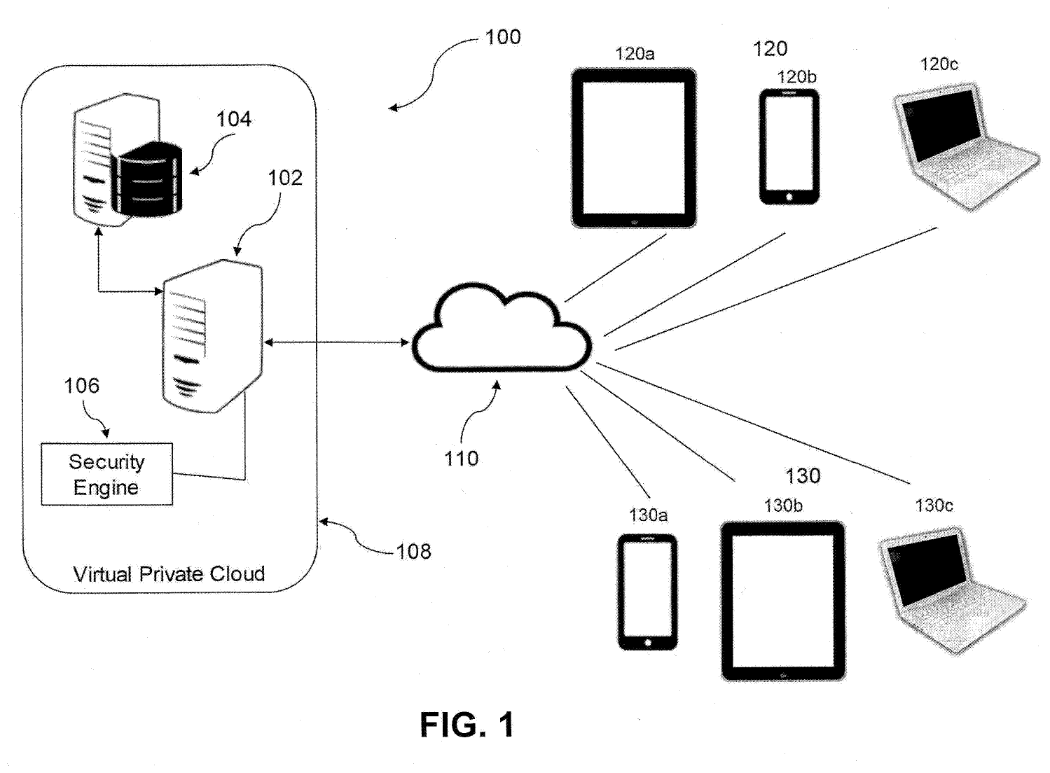

FIG. 1 illustrates a secure data acquisition and processing system 100 that implements a secure point of sale financing system. For illustrative purposes, several elements illustrated in FIG. 1 and described below are represented as monolithic entities. However, these elements each may include and/or be implemented on numerous interconnected computing devices and other components that are designed to perform a set of specified operations.

As illustrated in FIG. 1, the secure data acquisition and processing system 100 includes a secure point of sale (POS) system and server 102 that is accessible to a number of electronic computing devices and/or mobile computing devices (120, 130) through a network 110. The secure server 102 may be accessed by sales representative devices 120 and customer devices 130. The sales representative devices 120 may be used by a contractor offering financing products to customers in conjuction with construction and home improvement projects. The sales representative devices are internet capable computing devices 120 and may include, for example, a tablet computer 120a, a smartphone 120b, and a laptop computer 120c. The customer devices 130 may be used by a customer to apply for the financing offered in conjunction with construction and home improvement projects after receiving an initial invitation from the contractor. The customer devices are personal or mobile computing devices 130 and may include, for example, a smartphone 130a, a tablet computer 130b, and a laptop computer 130c.

In addition, the system 100 also includes a databse server 104 that operates in conjunction with the secure server 102. In one exemplary implementation, the various components of system 100 may be a group of interconnected computing devices such as secure server 102 and database server 104 that operate within a computing environment forming a virtual private cloud 108 that is securely accessible by the computing devices 120, 130 through the network 110.

The secure server 102 may be implemented using one or more computing devices (e.g., servers) configured to provide a service to one or more client devices (e.g., mobile computing devices 120, 130) connected to the secure server 102 over network 110. The one or more computing devices on which the secure server 102 is implemented may have internal or external storage components storing data and programs such as an operating system and one or more application programs. The one or more application programs may be implemented as instructions that are stored in the storage components and that, when executed, cause the one or more computing devices to provide the functional and security features, as well as processing engines, of the secure data acquisition and processing system that execute on the secure server 102. One particular processing engine executed by the secure server 102 is a security engine 106. The security engine 106 is primarily responsible for executing and handling the security protocols used to verify and authenticate data acquired from a loan applicant and determine that the applicant is the actual person applying for a loan. Furthermore, the one or more computing devices on which the secure server 102 is implemented each may include one or more processors for executing instructions stored in storage and/or received from one or more other electronic devices, for example over the network 110. In addition, these computing devices also typically may include network interfaces and communication devices for sending and receiving data. The secure server 102 also may provide an application programming interface (API) that enables other applications to interact with and extract data from the secure server 102 and database server 104.

The computing devices 120, 130 are typically mobile computing devices and may be any of a number of different types of computing devices including, for example, mobile phones; smartphones; personal digital assistants; laptop, tablet, phablet and netbook computers; and desktop computers including personal computers, special purpose computers, general purpose computers, and/or combinations of special purpose and general purpose computers. Each of the computing devices 120, 130 typically may have internal or external storage components for storing data and programs such as an operating system and one or more application programs. In particular, the internal or external storage components for each of the computing devices 120, 130 may store a client application for interfacing with the secure server 102 and database server 104. Additionally or alternatively, the computing devices 120, 130 may be configured to interface with the secure server 102 without a specific client application, using, for example, a web browser.

Each of the computing devices 120, 130 also typically may include a central processing unit (CPU) for executing instructions stored in storage and/or received from one or more other electronic devices, for example over the network 110. Each of the computing devices 120, 130 also usually may include one or more communication devices for sending and receiving data. One example of such communications devices is a modem. Other examples include antennas, transceivers, communications cards, and other network adapters capable of transmitting and receiving data over a network (e.g., the network 110) through a wired or wireless data pathway.

The network 110 may provide direct or indirect communication links between the secure server 102 within the virtual private cloud 108, and the various mobile computing devices 120a, 120b, 120c, 130a, 130b, 130c. Examples of the network 110 include the Internet, the World Wide Web, wide area networks (WANs), virtual private networks (VPNs), local area networks (LANs) including wireless LANs (WLANs), analog or digital wired and wireless telephone networks, radio, television, cable, satellite, and/or any other delivery mechanisms for carrying data.

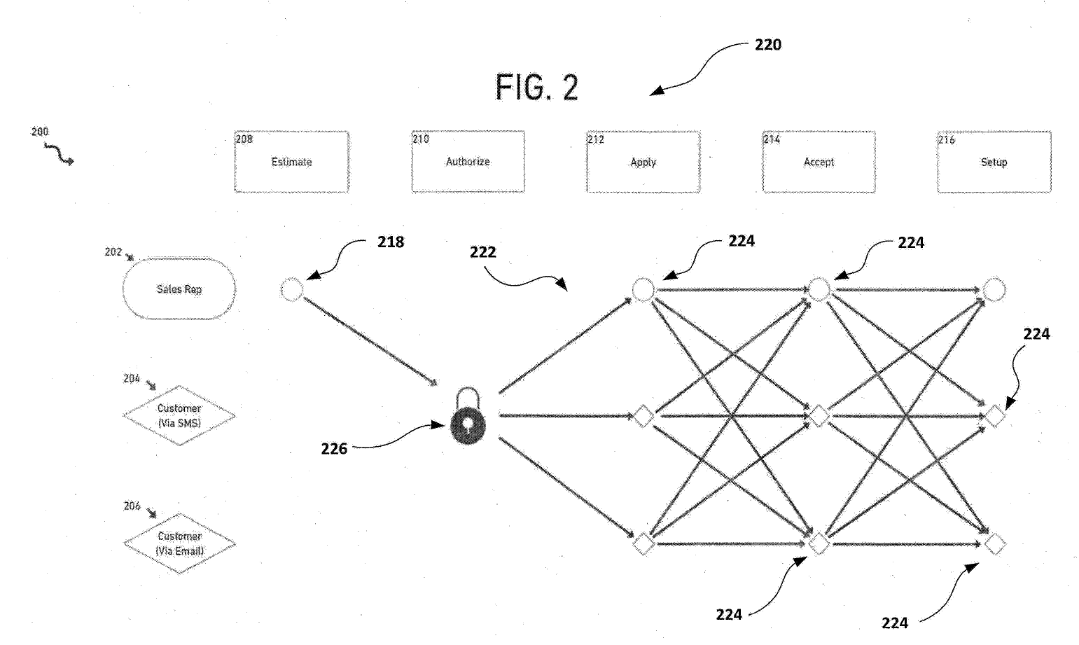

FIG. 2 illustrates an overview of the point of sale financing and secure data acquisition process 200, showing that the various phases of the loan application and secure data acquisition process can be completed through each of the available operating modes within the process. Process block 202 represents the process path of an internet capable computing device 120 associated with an agent or affiliate of the entity (e.g. financial institution) that is offering and approving the financial transaction and distributing the approved funds. In this exemplary implementation, the agent is a sales representative or contractor working with a customer (at process block 202) to develop an estimate for a home improvement project, such as replacement windows, where the customer is also considering applying for a loan to finance the home improvement project. The contractor is able to use the process 200 to develop an estimate for the home improvement project, and then as a next step use the process 200 to offer a financing solution to the customer to pay for the project with monthly installments. The computing device 120 may include any internet capable computing device (e.g. smart phone, phablet, tablet, laptop or desktop computer) that is capable of running an application and communicating with a server, and also establish a secure communication session. Process block 202 also represents all of the operations that execute on the computing device 120 associated with the contractor.

Process block 204 represents the process path of the customer interacting with the financing and secure data acquisition process 200 via a computing device 130 capable of executing an SMS based communication protocol. In one implementation the contractor initiates an invitation process through the application running on their computing device 120 (process 202) that causes the secure server 102 to push a SMS message to the mobile phone number provided by the customer. Assuming the customer provides the correct mobile phone number, the customer receives the SMS message on their personal or mobile computing device 130 that contains a link to the secure server 102 hosting the process 200. The customer initiates a secure communication session with the secure server 102 hosting the process 200 by selecting the link contained in the SMS message, which in turn launches a browser-based customer application portion of process 200.

Process block 206 represents the process path of the customer interacting with the financing and secure data acquisition process 200 via a computing device 130 capable of executing an email-based communication protocol, typically through a wired or Wi-Fi based internet connection. In this alternate implementation the contractor initiates an invitation process through the application running on their computing device 120 (process 202) that causes the secure server 102 to push an email message to the email address provided by the customer. Assuming the customer provides the correct email address, the customer receives the email message on their personal or mobile computing device 130 that contains a link to the secure server 102 hosting the process 200. The customer initiates a secure communication session with the secure server 102 hosting the process 200 by selecting the link contained in the email message, which in turn launches a browser-based customer portion of process 200.

The process 200 executes the point of sale financing and secure data collection and/or acquisition functions through a group of execution phases 220 shown along the top of FIG. 2. The execution phases 220 include an estimation phase 208, an authorization phase 210, an application phase 212, an acceptance phase 214, and a setup phase 216. As part of the estimation phase 208 the contractor develops a cost estimate of a construction project based on the scope of work for the construction project requested by, for example, a homeowner (customer) that desires a loan to finance the construction project. Example projects are typically selected from a list of generally defined home improvement and renovation projects such as replacing windows, doors, gutters, roofs, heating and air conditioning systems, hot water heaters, plumbing fixtures, electrical fixtures, kitchens and bathrooms. Features within the estimation phase 208 include a cost estimation tool to assist the contractor with completing the cost estimate based on, for example, the scope of the work to be completed and the quality level of the materials or fixtures. The features and functions performed within the estimation phase 208 can only be completed at process node 218 using the contractor side application running on the contractor's device 120. One of the reasons for this restriction is to enhance the security of the process 200. Another reason for this restriction is sales enablement, which allows the contractor exclusive control over inputting the scope of the work and the estimated project costs. This in turn provides the contractor with an enhanced sales tool for presenting details of the estimated project costs and quality of the finished remodeling project, and also presenting various financing and payment options available to the customer through the financial institution. During the estimation phase 208, the estimated project costs and financing and payment options are only displayed on the contractor's computing device 120, and are not yet available for viewing on the customer's computing device 130. Once the customer and contractor reach agreement on the scope of work and the estimated costs for the construction project, the process 200 saves all of this information back to the secure server 102 and database 104 so that other execution phases 220 in the process 200 will have access to all of the information relating to the construction project and to the available financing and payment options. Once this information is saved it may also be manipulated later in the application by the contractor running the application on their computing device 120. At application phase 212 and acceptance phase 214 the project or projects can be changed using an “Edit Offer” feature. At setup phase 216 the project(s) can be changed by submitting a change order.

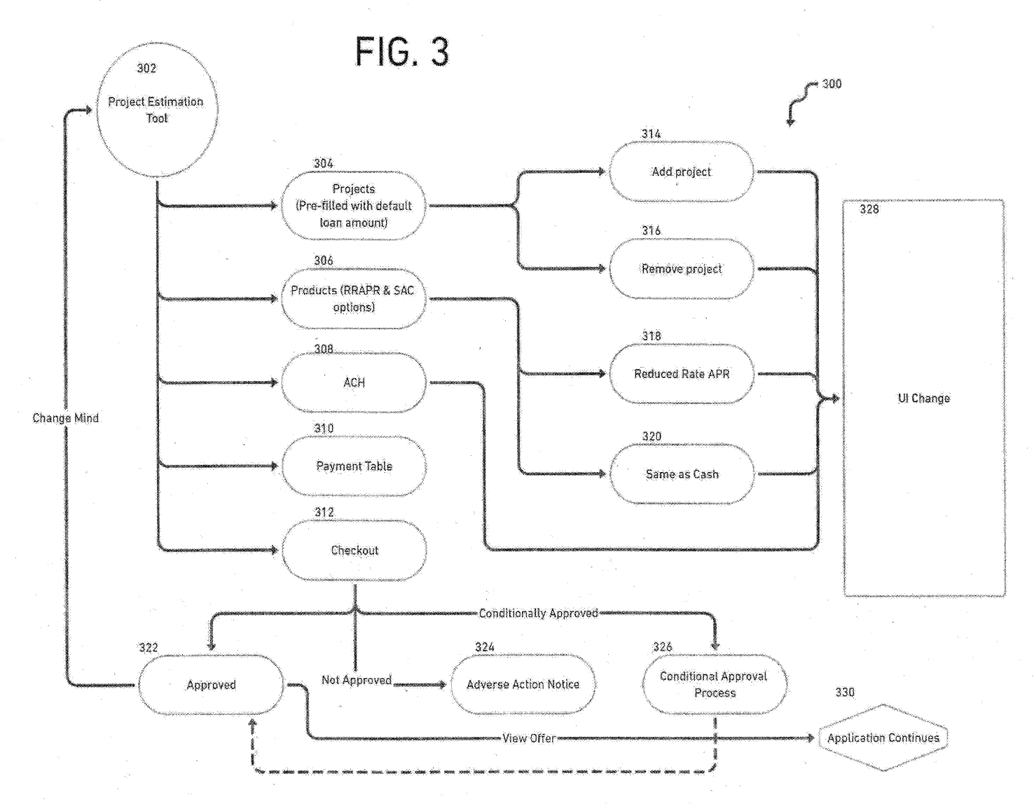

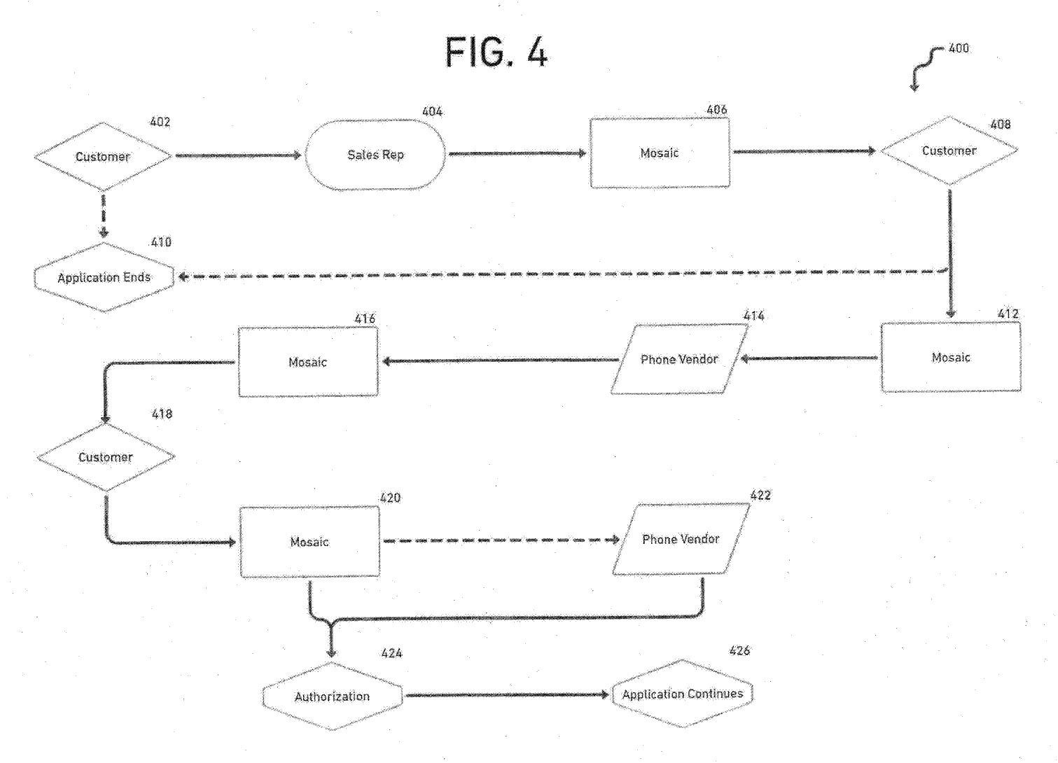

The secure authorization phase 210 is the process through which the customer receives either an SMS message or an email message (depending on the type of computing device they are using, and their connection to the internet) to confirm their presence as the true borrower and person being extended credit, and to confirm authorization of the loan application through the process 200. Additional details of the secure authorization phase 210 are shown in FIGS. 3 and 4, and are described in greater detail below.

The application phase 212 is the series of steps in the process 200 through which the customer actually applies for the loan. In this phase, the customer applies for credit, and in response is able to view the amount of credit that the financial institution is willing to extend to the customer. The decisioning process on the line of credit extended to the customer is specifically designed and implemented to ideally take no more than six seconds from initiation by the customer to receiving a credit decision. Once a credit approval is received, the customer can proceed through one of several options. For example, as a next step (option) the customer may choose a particular loan product and borrowing amount if they skipped the step of selecting a particular loan product within the contractor's project estimation tool (208) at the time the estimate for the construction project was presented to the customer. The customer may also confirm a particular loan product and borrowing amount if they already expressed a preference in the contractor's project estimation tool (208). Alternatively, the customer may be provided with the option to revise their loan product and borrowing amount. For example, the contractor may wish to upsell additional features, upgrades, quality of materials or other enhancements in the construction project in situations where the customer is approved for a larger project loan amount (e.g. based on their established credit history and/or credit rating scores). The customer also may want to revise their loan product and borrowing amount in the event that their credit approval is for an amount that is less than what they requested through the project estimation phase 208 or through the application phase 212. Additionally, the customer may want to revise their loan product and borrowing amount for a variety of other reasons before formally accepting the loan amount, including a change in the scope of the work that reduces the estimated project costs (e.g. submitting a change order).

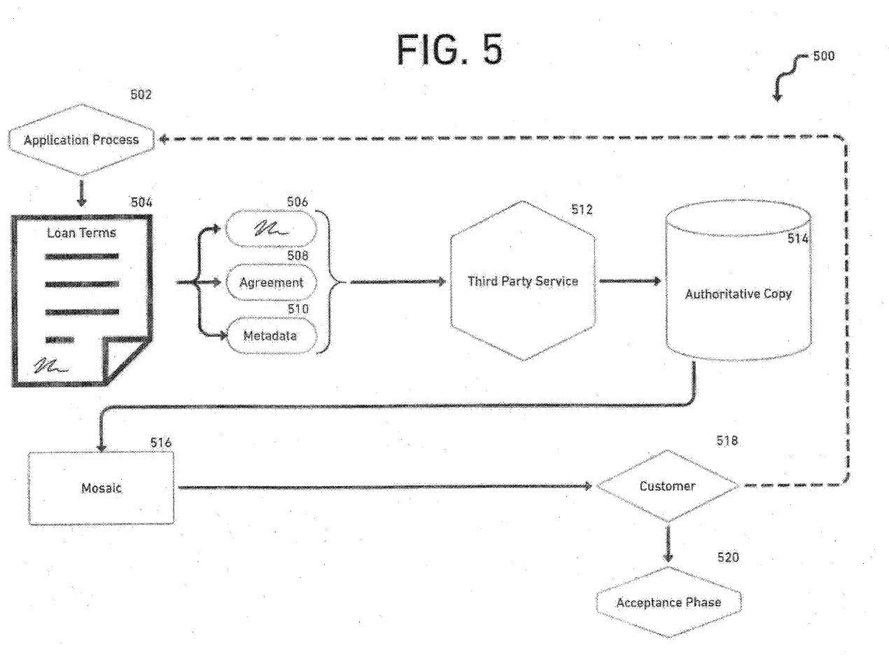

The acceptance phase 214 is where the customer is able to view the terms of the loan product on their own personal computing device 130. When the customer is ready to proceed with formally accepting the loan amount, the customer is able to accept the terms of the loan product using a secure electronic signature process, described in greater detail below with reference to FIG. 5.

The setup phase 216 allows the customer (borrower) to configure automated clearing house (ACH) information by entering bank routing number and customer account number information through a secure interface. Additional optional features within the setup phase 216 may include features that allow the customer to set up alert notifications or other future notifications that they wish to receive from process 200, enter one or more contact preferences that might include a secondary email address or phone number, view next steps relating to either timing or process for distribution of the funds, provide referrals about the point of sale process and/or a particular contractor to friends and contacts within their network, post information about their experience on one or more social media sites, and optionally respond to a satisfaction survey to provide feedback about their experience with the point of sale process 200. To enter ACH information, the customer is prompted to enter their bank routing number and bank account number. Alternatively, the customer may wait until the financial institution receives the first installment (payment) check from the customer. If the customer is not enrolled in ACH when the financial institution receives the customer's first payment check, the financial institution is able send the customer an invitation asking the customer if they would like to enroll in ACH. If the customer agrees to ACH enrollment, the financial institution is able to automatically fill in the required ACH routing information for the customer based off of the customer's check. Another option allows the customer to take and securely forward a photo of a cancelled check. Yet another option allows the customer to securely login to their bank account through a third party vendor and select the specific bank and bank account they would like ACH to withdraw funds from.

The setup phase 216 also includes a feature that allows the customer to confirm (via SMS messaging) that installation of the home improvement project is complete. The contractor can log into their application, and with one click (on the specific project line item), request confirmation from the customer that installation is complete (project confirmation). This triggers the process 200 to push an SMS message to the customer that they can respond to with a “Yes” to confirm completion of the specific project. This confirmation then automatically triggers disbursement of funds directly to the contractor for that project. The SMS confirmation feature is disabled for customers whose phone number is unauthorized or unauthenticated. The setup phase 216 also allows the contractor (when using the contractor portion of the application running on their computing device 120) to submit a change order to modify the project and project cost. Additionally, the setup phase 216 also allows the customer to request changes to the loan (e.g. borrowed amount, length of loan), even after the particular loan product has been finalized and signed.

The setup phase 216 will also involve the use of a “welcome call” via SMS messaging. This process involves a series of questions confirming customer understanding and consent. The welcome call may be performed via telephone, but the financial institution may provide customers the option of answering a series of questions via SMS messaging. At any time, the customer will be able to opt out of SMS messaging (and opt into a phone call). The process 200 will confirm that customer location is within the premises of the household via a one-time query to the cell provider.

The matrix 222 (and the directional arrows connecting the various nodes 224) shown below each of the execution phases 208, 210, 212, 214, and 216 represents the stepwise flow through each execution phase in the process 200. The arrows represent the ability to move to and from different nodes 224 along a particular process path of each process block (202, 204, 206) to the next execution phase of the secure data acquisition process 200. For example, a customer may start the process 200 along process path 204 (invitation via SMS) within the secure authentication phase 210, and then at a later time continue with subsequent execution phases of the process 200 along process path 206 (invitation via email) within the application phase 212. If the customer was interrupted before completing all execution phases of the secure process 200, their data would be saved by the secure server 102 and database 104, and the customer could continue the process 200 at a later time along process path 204 using their mobile phone and interact with the process 200 within the acceptance phase 214. The flexibility provided by the secure data acquisition process 200 does not limit the customer from completing the various execution phases 220 with the same computing device (e.g. mobile phone) that was used to initiate the process 200. The lock symbol at node 226 represents that the secure authorization phase 210 can only be completed by the customer along the process path of process block 204 via SMS messaging.

With reference to FIG. 3, the features of the project estimation process 300 are described in greater detail. Central to the project estimation process 300 is the project estimation tool 302, which includes a projects module 304, a financial products module 306, an ACH data entry module 308, an amortization module 310, and a check out module 312.

The projects module 304 includes a list of pre-defined construction projects, each having a defined scope of work and complete description of project details. Each of the pre-defined construction projects are pre-filled with a default loan amount. Within the projects module 304 of the project estimation tool 302, customers can add projects (314) or remove projects (316) as part of the overall project planning process. Projects can only be added (314) if the cost of the additional projects do not exceed the customer's or financial institution's borrowing limits. If the customer no longer wants one of the pre-defined construction projects, or a customized construction project, a particular project may be removed from the selection (316) and a new borrowing total will be redisplayed to the customer.

The financial products module 306 includes two distinct types of financing products that can be offered to the customer. The financing products include reduced rate annual percentage rate (APR) and same as cash financing products. When the customer selects the reduced rate APR financing product (318), the user interface on their computing device 130 displays a monthly payment amount.

In one implementation, when the customer selects the same as cash financing product (320), the interface on their computing device 130 will display, for example, a $0 per month payment for up to 18 months (or another predetermined period of time selected by the financial institution), followed by their monthly payment after the promotional period has ended. The application and interface on their computing device 130 also displays a slider to show savings achieved by paying the loan amount off early. The application may optionally display a variety of features including a “before promo” (same as cash period) and an “after promo” (same as cash period) payment. The application may optionally allow the customer to simulate pre-payments to the loan and then display how various pre-payments might lower the customer's monthly payment and also display interest saved through the simulated pre-payment amounts.

The ACH selection and data entry module 308 provides the customer with the option to make their monthly payments through the ACH process in which a set monthly payment is automatically withdrawn from a designated bank account. When the customer selects this choice, the discounted monthly payment is then displayed within the application running on their computing device, and the savings achieved by selecting ACH payments is also displayed. The amortization module 310 provides a selection button within the interface which allows the customer to open a payment table at any time in order to see a full principal and interest breakdown of their loan.

The checkout module 312 provides a selection button within the interface that allows the customer to save their settings and choices that were filled in (back to the secure server 102 and database 104). The settings and choices represent the particular features, loan amount, and repayment terms of the financial product that the customer selected. When the customer is ready to proceed with a complete credit check (credit verification), the secure process 200 executes steps within the secure authorization phase 210 in order to verify the identity of the customer (i.e. the secure process 200 branches to block 402 of authorization process 400). The details of the secure authorization phase 210 are described in greater detail below with reference to FIG. 4. Once the steps of the authorization process 400 are complete and the authentication status of the customer is known, the process 200 returns to the checkout module 312, and a complete verification of the customer's credit history is performed using industry standard credit verification processes through at least one third party credit reporting service. The checkout module 312 receives and processes the customer's credit history information so that the secure process 200 is able to make a decision of whether (or not) to approve the requested loan. Based upon the decision criteria within process 200, the customer will receive a reply that they are approved through an approval process (322), conditionally approved (326), or not approved (324). If the loan for the customer is approved (322), processing may optionally continue back to the main screen of the project estimation tool 302 which allows the customer the option to change their mind and make adjustments to the construction project by returning to the various screens and modules within the project estimation tool 302. Alternatively, if the loan for the customer is approved (322), processing may continue to processing block 330. At processing block 330, the loan application process 200 proceeds to the e-signature process (500, 502), described in greater detail in relation to FIG. 5. If the customer receives a conditional approval (326), the process may present a request for additional identification documentation, income documentation, other underwriting documentation, or a live phone call with the customer to request clarification of information in their credit history report. The conditional approval (326) may include any number of processes or actions depending on the current credit and lending policies of the financial institution's credit department. If the customer is not approved (324) for the requested loan amount, the secure process 200 will send the customer an adverse action notice (324).

As a separate feature of the approval process (322) with the approval module, the customer is able to view additional offers from the financial institution and continue with the loan application. Additionally or alternatively, the customer can change their mind and return to the main screen of the project estimation tool 302. Continuing the loan application process will save all of the customers selected choices back to the secure server 102 and database 104.

The user interface updating module 328 represents the graphics update processes on the customer's computing device 130 where the application user interface is updated in real time to reflect new totals, a revised monthly payment, annual percentage rate, and/or savings amount. The real time updating process executed by updating module 328 allows the customer (as a borrower) to instantly see how their different choices will affect the loan terms.

FIG. 4 illustrates the process and features (400) of the secure authorization phase 210 in greater detail. Because the process 200 can be implemented on a wide range of current and future computing devices, including mobile computing devices and smart phones, the secure authorization phase 210 is configured to implement a secure communication connection between the customer's computing device 130, the secure server 102, and the security engine 106. The secure authorization phase (210), shown as process 400, executes a series of security and information processing steps that are implemented to establish a secure communication session with the customer, verify the identity of the customer, verify that the customer is the actual owner of the mobile phone number provided as part of the loan application process, and prevent the submission of fraudulent loan applications, while also providing a streamlined application process for the customer that is as convenient and seamless as possible.

The secure customer authorization process 400 begins with the customer (at 402) providing their mobile phone number to the contractor. The contractor (at 404) can enter the customer's phone number into the point of sale process system 200 application running on the contractor's computing device 120, and by doing so send the mobile phone number to the secure server 102. The secure server 102 at processing step 406 receives the customer's phone number and automatically sends an SMS invitation message to the customer's phone or mobile computing device 130 requesting authorization from the customer to begin a secure loan application process. Processing step 406 is not typically configured to present a challenge question to the customer, but rather serves to verify both the presence of the actual customer, and approval by the customer to proceed with the loan application process. At processing step 408 the customer receives the SMS invitation message. As will be described in greater detail below, the customer can proceed with the secure authorization process 400 as long as their phone or mobile computing device 130 has an active internet connection back to secure server 102 and security engine 106. This connection can be through an active cellular or mobile network connection, or through Wi-Fi or a wired connection. The secure authorization process 400 requires the customer to provide their mobile phone number as a critical verification step. If the customer does not provide their mobile phone number or reply to the SMS invitation message indicating their consent, the secure authorization process 400 and application process 200 stops at step 410.

Process step 412 determines whether the customer's computing device 130 is actively connected to cellular network service using their mobile computing device in order to receive and respond to the SMS invitation message, and thus provide the necessary consent. Alternatively, process step 412 can determine whether the customer's computing device 130 is connected to the Internet through, for example, an active wi-fi or wired network connection that allows SMS based messaging between the customer's computing device 130 and the secure server 102.

At process step 414, the secure server 102 retrieves information from the mobile network carrier using the customer's phone number in response to the customers consent. This process is facilitated and implemented through an application programming interface (API) that is customized for the application process 200 and the secure server 102. The process is configured to allow the secure server 102 and security engine 106 to instantaneously query the customer records database of the mobile network carrier and receive a near instantaneous reply from the mobile network carrier to verify the identity of the customer, and to confirm the customer is the actual person using the secure loan application process 200.

At process step 416, the financial institution via secure server 102 and security engine 106 receives the actual customer identity information that was retrieved from the customer records of the mobile network carrier in process step 414. The secure server 102 and more specifically the security engine 106 further analyzes and processes the customer's information to create a customer identity record for use in the secure loan application process 200, along with any additional necessary customer information that is retrieved. To further automate and streamline the customer experience with using the secure loan application process 200, at process step 418 the secure server 102 populates fields in the user interface of the application running on the customer's mobile computing device 130 with the required customer information received from the mobile network carrier. For enhanced security purposes, the secure server 102 and process 200 do not fill in the customer's Social Security number on the application running on the mobile computing device 130.

Once all of the required customer information is entered into the application running on the customers phone or mobile computing device 130, the customer is prompted to confirm this information at step 420 and move to the next phase of the application process. Once the customer presses a suitably designed button (e.g. “apply” or “see if I qualify”) displayed in the user interface to confirm proceeding to the next step, the application sends the collected customer information through a secure connection back to the secure server 102. If a customer has changed any of the pre-filled information, an analysis process running on the secure server 102 will identify any changed information as new information, and the analysis process will then send this new information back to the mobile phone service carrier for confirmation. At step 422 the mobile phone service carrier performs a comparison between the new information and their customer records to confirm whether or not the new information provided by the customer is still consistent with their records for that particular customer. If the information being verified is not consistent with the records maintained in the mobile network carrier database, the customer's mobile computing device 130 will be denoted by the security engine 106 in the secure system 200 as being used with an unauthorized or unauthenticated phone number. The process 200 will then present additional security measures later in the application process. Once the necessary security requirements are satisfied, the customer will be able to proceed in the application.

If the information submitted by the customer matches the records maintained by the mobile network carrier, or if any new information provided by the customer is consistent with the database records of the mobile network carrier, the customer's mobile computing device 130 is authorized and/or authenticated by the security engine 106 at process step 424, and the secure loan application process 200 continues. In one implementation, as an additional security check, the security engine 106 and the secure server 102 perform a comparison between the name provided by the customer (as asserted by the mobile network carrier as the owner of the mobile phone number, or edited by the customer) and the name associated with the customer's social security number from information received from a commercial credit reporting service. The secure customer authorization process 400 serves to reduce future security and verification steps to ensure a streamlined application process. In the event that the customer's mobile computing device 130 cannot be verified and authorized, additional authentication and authorization steps are required before the secure application process 200 will continue to next steps using the unauthorized mobile computing device. Additionally, the particular mobile computing device is flagged as an unauthorized and/or unauthenticated device by the security engine 106 using the unique mobile computing device identification number (e.g. the unique MAC address, unique fifteen-digit IMEI number, or other unique identification number or information associated with the mobile computing device).

Once the identity of the customer is verified, and the customer's mobile computing device 130 is authorized and/or authenticated, the loan application process 200 continues at process step 426, and processing continues back to the processing steps executed by checkout module 312. The processing steps at checkout module 312 cause the secure server 102 and security engine 106 to retrieve credit information from a third party commercial credit reporting service, often referred to as a credit pull. If the customer's credit meets pre-established criteria for the financial institution, the customer is approved for credit financing, and the secure loan application process 200 moves from the authorization phase 400 into the application phase 500.

The system that executes secure process 200, and therefore the financial institution, implements a fraud prevention process to verify that the customer (loan applicant) is aware of the transaction, that the customer is a real person, that the customer is applying for credit themselves (as opposed to someone impersonating the customer), and that the customer owns the phone or mobile computing device so that the secure process 200 and financial institution can trust SMS communications with the customer. The techniques of this fraud prevention process implement a user interface and user experience that is low-friction to the customer.

The security features implemented within the fraud prevention process can generally be characterized by four steps. The first step involves awareness verification, which is a step to verify that the customer (loan applicant) is aware of the transaction. As an additional convenience feature, once customer awareness is verified, the appropriate screen(s) in the application can be pre-populated with the customer's identifying information (including but not limited to first name, last name, address, and preferred email or phone contact number) which the customer authorizes to be retrieved from the customer's records maintained by the mobile network carrier.

The awareness verification step is initiated after the customer (or prospective loan customer) provides their mobile phone number to the contractor (402). The contractor (404) enters the customer's phone number into the contractor (only) version of the loan application (referred to above as process 202) which causes an SMS message to be sent to the mobile phone or mobile computing device 130 of the customer (406). The SMS message asks the customer to type and send the reply of “Yes” to the financial institution (408). When the “Yes” reply is received, the awareness verification step is considered to pass (412). If the customer chooses not to respond to the SMS message, or responds with something other than the requested “Yes”, the awareness verification step is considered to fail (410), and the customer cannot proceed to apply for a loan (using the interactive application described as secure process 200) with the financial institution.

The second step involves mobile number ownership verification, which is a step to verify the customer owns the actual phone number provided to the contractor at the outset of the loan application process (e.g. secure process 200). After the awareness verification step is considered to pass, the application (typically executing through a browser) running on the customer's mobile computing device 130 presents the customer with a screen requesting the customer to enter their mobile phone number (a unique number personal to and identifying the customer).

In one implementation, the customer may enter the digits of their mobile phone number and press a button displayed on the screen that says “Verify”. If the customer is connected to a mobile wireless network, the mobile number ownership verification process executes in the background through a third party service provider. If the verification process determines that the customer does in fact own the mobile number entered, the application will then present a screen that displays a confirmation of “Verified”. If the verification process determines that the customer is not the true owner of the mobile number entered (e.g. number incorrectly entered; potential fraud), the application will then present a screen that displays a message that mobile number ownership could not be verified. The customer may be prompted to “try again”, and if after a certain number of attempts the mobile number still cannot be verified, the application may stop prompting for retries and may ask the customer to try again later. Alternatively, the verification process may flag the mobile number as unauthenticated, but the application will allow the customer to continue with further steps of the loan application process, pending additional verification steps downstream. The verification process is implemented to return a near instantaneous mobile number ownership verification (or no verification) reply to promote a frictionless user experience.

In another implementation, if the customer is not connected to a mobile wireless network, but is able to connect their phone or mobile computing device 130 to the internet through Wi-Fi, the verification process is still able to execute in the background through the third party service provider. The customer will be asked to enter their mobile phone number and press a button displayed on the screen that says “Verify”. The next screen presented will ask the customer to enter a unique code. The customer will also receive a text message on their phone or mobile computing device 130 that contains a code (e.g. a six-digit number). The customer enters the unique code and presses a button on the screen that says “Verify”. If the verification process determines that the customer does in fact own the mobile number entered, the application will then present a screen that displays a confirmation of “Verified”. If the verification process determines that the customer is not the true owner of the mobile number entered (e.g. number incorrectly entered; potential fraud), the application will then present a screen that displays a message that mobile number ownership could not be verified. The customer may be prompted to “try again”, and if after a certain number of attempts the mobile number still cannot be verified, the application may stop prompting for retries and may ask the customer to try again later. Alternatively, the verification process may flag the mobile number as unauthenticated, but the application will allow the customer to continue with further steps of the loan application process, pending additional verification steps downstream. Whether using SMS or Wi-Fi based communication protocols, the mobile number ownership verification process is implemented to return a near instantaneous ownership verification (or no verification) reply to promote a frictionless user experience.

When the customer interacts with the application (typically through their browser) on their mobile computing device 130, one of the next screens presented to them is a screen showing their pre-populated customer identifying information which will be used (later in the loan application process) for applying for a loan. The customer has the choice of reviewing and confirming that the information displayed is correct and selecting a “confirm” button, or alternatively making changes to the information and selecting an “update” button. If the customer confirms the identifying information as correct, a trusted third party service performs a comparison between the identifying information in the application (e.g. process 200) and the customer's information maintained by the customer's wireless phone service provider (customer records database). If the customer makes changes to the identifying information, but a comparison (executed by the trusted third party service) between the updated information and the customer's information maintained by the wireless phone service provider produces a high confidence “fuzzy match” (e.g. fuzzy match confirmed by the trusted third party service), the mobile number ownership verification step is also considered to pass.

If the information does not match, the mobile number ownership verification step is considered to fail. The customer is able to proceed with further steps in the loan application process, but the mobile phone number is temporarily flagged as unauthenticated. The system executing secure process 200 may optionally present additional verification steps to the customer downstream in the loan application process before the loan application can be finalized and funds dispersed. The process 200 also collects unique identifying information associated with the mobile computing device, such as the IMEI/IMSI codes which provide a digital fingerprint of the mobile phone or mobile computing device 130. In situations where the mobile number ownership verification step fails, the unique identifying information (e.g. IMEI/IMSI) may be placed on a watch list maintained internally to the financial institution to ensure the same mobile computing device or phone number is not applying for multiple loans.

The third step involves identification (ID) verification (first factor) of the personally identifiable information (PII) of the customer to verify that the customer is a real person. In one implementation the customer is asked to enter their personally identifiable information including, but not limited to, their first name, last name, social security number (SSN), date of birth, and residence address. The PII is then passed to another trusted third party (e.g. a recognized credit reporting service) which allows the financial institution to verify that the PII provided belongs to a real person, and also allows the financial institution to perform a complete credit check for the customer. Based on the information returned from the credit reporting service, the financial institution can make a decision about whether or not to extend credit to the customer, and the amount of credit to extend, based on, for example, the reported income and borrowing and credit history for the particular customer. In certain situations, the customer may be conditionally approved for credit and then later asked to provide additional supporting documentation for further review (e.g. documenting current income).

The fourth step involves identification (ID) verification (second factor) to verify that the owner of the phone number is also the same person actually applying for credit. The second factor verification step prevents someone impersonating a customer (or potential customer) with a stolen ID from using the stolen information to apply for credit. In one implementation the verification is performed by the credit reporting service, which executes a fuzzy matching process of the name of the phone number owner (ownership previously verified) provided in the second verification step above (number ownership verification) with name of the social security number (SSN) owner. In an alternate implementation, the verification is performed by the security engine 106 which executes a fuzzy matching process of the name of the phone number owner (ownership previously verified) provided in the second verification step above (number ownership verification) with name of the social security number (SSN) owner based on data retrieved from the credit reporting service. If the second factor verification step is considered to pass, the customer applying for a loan is then considered fully verified. This name matching (second factor) verification technique provides the advantage of performing customer identity verification with a high level of confidence in a very short amount of time, which in turn provides for an improved customer experience. If the second factor verification is considered to fail, the customer can still proceed with the loan application, but the phone number is flagged as unauthenticated. This may require the customer to present additional information or complete additional verification steps downstream in the loan application process before the loan application can be finalized and funds dispersed. The process 200 may also collect unique identifying information associated with the mobile computing device at this step, such as the IMEI/IMSI codes which provide a digital fingerprint of the mobile phone or mobile computing device. In situations where the second factor ID verification step fails, the unique identifying information (e.g. IMEI/IMSI) may be placed on a watch list maintained internally to the financial institution to ensure the same mobile computing device or phone number is not applying for multiple loans, or to prevent a stolen phone or stolen identification from being used to fraudulently apply for a loan.

If the second step (phone number ownership verification) and the fourth step (second factor ID verification) both pass, the phone number is flagged as authenticated. If either one of the second step (phone number ownership verification) or the fourth step (second factor ID verification) fail, the phone number is flagged as unauthenticated.

FIG. 5 Illustrates the process and features of the application phase (212) that implements the e-signature process (500), and the generation of a secure copy of the loan agreement. The secure application process 200 continues with additional interaction with the customer at process block 502. At step 504 the browser or application running on the customer's mobile computing device 130 displays a summary of loan terms followed by a signature box. After reviewing either the summary of the loan terms, or the complete loan agreement, the customer may electronically sign the loan agreement through their phone or mobile computing device 130. The electronic signature placed within this box may be drawn by the customer with their finger, a stylus, or may be drawn by the customer with a mouse cursor. The customer may click on the loan terms to bring up a full preview of the complete loan agreement to ensure maximum transparency. Block 506 represents an image file version of the customer's electronic signature. Block 508 represents a full copy of the complete loan agreement in PDF file format. Block 510 represents all of the metadata associated with the complete signed loan agreement. The metadata may include, for example, one or more of the complete name of the borrower, their email address and phone number used in the authentication process, loan agreement execution time, execution date, the e-signature consent language, IP address of the phone or mobile computing device 130 used to the submit and sign the complete loan agreement, and any other data representing information about the complete loan agreement.

At process block 512 a third party service securely generates an authoritative copy of the loan agreement by combining the elements of the signed loan agreement including the e-signature 506, complete loan agreement 508, and metadata 510 into an official legal and authoritative copy of the signed loan agreement. The combined elements are then cryptographically sealed in order to create an original legal and authoritative copy of the signed loan agreement that is then stored in a specialized secure storage database 514 specifically designed for storing electronic copies of completed loan agreements. The financial institution does not receive a copy of the authoritative copy of the signed loan agreement. The authoritative copy of the signed loan agreement remains in the secure storage database 514, and may be transferred to capital providers if/when the financial institution sells the loan. At process step 516, a non-authoritative copy of the signed loan agreement is then instantly sent to the financial institution which stores this non-authoritative copy and links the non-authoritative copy to the customer's unique application identification number.

At process step 518 the financial institution sends a link to the customer's mobile computing device 130 which allows the customer to view the non-authoritative copy. The link may be sent via SMS message and/or email message. The SMS message or email message also contains a button or a link that allows the customer to cancel the loan with a single click or response within a predetermined time period, for example, seventy-two (72) hours.

The customer also has the ability to request pre-disbursement change orders through the contractor, which would allow the loan terms to be adjusted. The change order process must be initiated through the contractor using the contractor's computing device 120 which is logged in through the contractor application. The contractor initiates the change order by selecting a button in the user interface that confirms the contractor wants to void the old agreement. The change order process causes the customer to return to the acceptance process 214.

Once the e-signature process 500 within the application phase 212 is complete, the secure loan process 200 continues to the acceptance phase 214 referenced in FIG. 2.

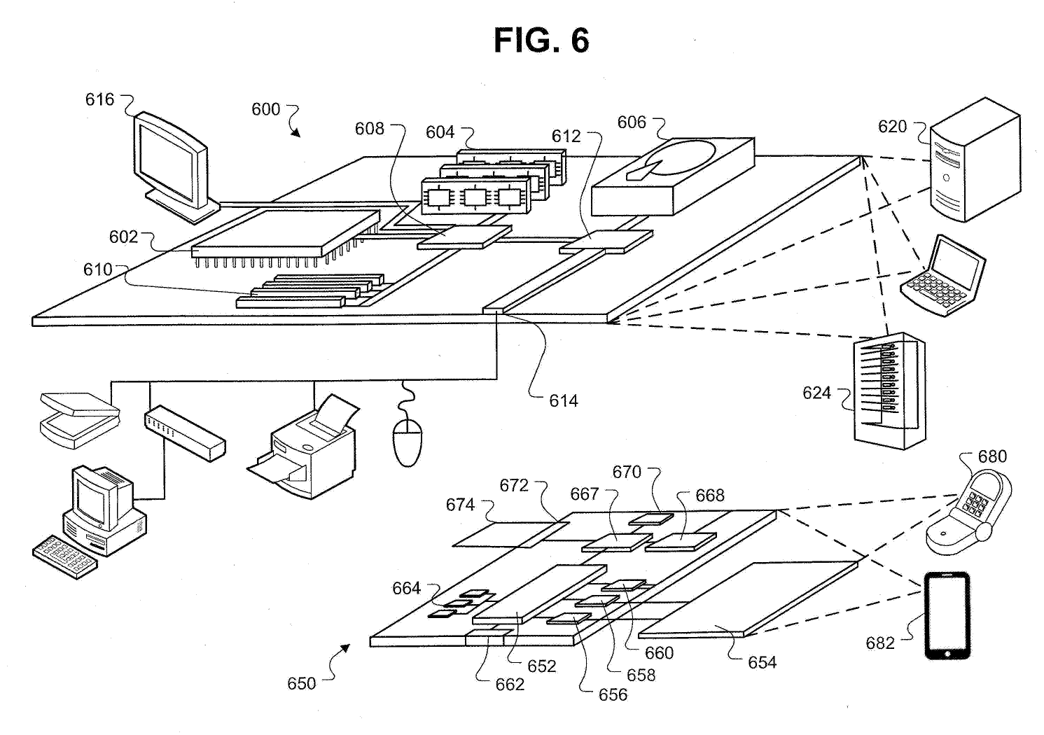

FIG. 6 shows an example of a computing device 600 and a mobile computing device 650 that can be used to implement the techniques described here. The computing device 600 is intended to represent various forms of digital computers, such as laptops, desktops, workstations, personal digital assistants, servers, blade servers, mainframes, cloud computing systems, and other appropriate computers. The mobile computing device 650 is intended to represent various forms of mobile devices, such as personal digital assistants, cellular telephones, tablet computers, smart-phones, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk, or a solid-state drive memory device.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 602), perform one or more processes or methods, such as those described above. The instructions can also be stored by one or more storage devices such as computer- or machine-readable mediums (for example, the memory 604, the storage device 606, or memory on the processor 602).

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers, such as a cloud computing system or a virtual private cloud. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 667, and a transceiver 668, among other components. The mobile computing device 650 may also be provided with a storage device, such as a micro-drive or other device, to provide additional storage. Each of the processor 652, the memory 664, the display 654, the communication interface 667, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory and/or processor 674 may also be provided and connected to the mobile computing device 650 through an expansion interface 672, which may include, for example, a SIM (subscriber identity module) card interface. The expansion memory 674 may provide extra storage space for the mobile computing device 650, or may also store applications or other information for the mobile computing device 650. Specifically, the expansion memory 674 may include instructions to carry out or supplement the processes described above, and also may include secure information such as unique identifying numbers or security keys. Thus, for example, the expansion memory 674 may be provided as a security module for the mobile computing device 650, and may be programmed with instructions that permit secure use of the mobile computing device 650. In addition, secure applications may be provided via the SIM cards, along with additional information, such as placing identifying information on the SIM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 667, which may include digital signal processing circuitry where necessary. The communication interface 667 may provide for communications under various modes or protocols, such as 4G, 5G, GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, Wi-Fi, near-field communication (NFC) or other such transceiver. In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, tablet, phablet, personal digital assistant, or other similar mobile computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, solid state drives, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A secure data acquisition and processing system comprising:
a secure server configured to execute one or more secure data acquisition processes during interaction with a mobile computing device operated by a user;
the secure server including a security engine configured to execute instructions received from the secure server, the instructions causing the security engine to perform operations including:
tracking information uniquely identifying the mobile computing device that interacts with the secure server; and
authentication processing on the user of the mobile computing device to verify and authenticate that the user of the mobile computing device is the owner of the mobile phone number used with the mobile computing device interacting with the secure server.

2. The system of claim 1 wherein the security engine performs a two step verification process.

3. The system of claim 2 wherein the two step verification process includes the security engine executing a fuzzy matching process between a common data element retrieved from two distinct data sources that independently store the common data element.

4. The system of claim 3 wherein the common data element is a name identifier of the owner of the mobile computing device, and the two distinct data sources are a mobile network carrier database and a credit reporting service database.

5. The system of claim 1 wherein the secure server combines a completed loan application with metadata related to the loan application, and then performs an encryption process to cryptographically seal the loan application with the metadata to create an authoritative copy of the loan application.

6. The system of claim 5 wherein the secure server stores the cryptographically sealed authoritative copy in a secure database.
